(19) United States
(12) Patent Application Publication
(10) Pub. No.: US 2016/0167675 A1
(43) Pub. Date: Jun. 16, 2016

(54) SYSTEM, METHOD, AND VEHICLE FOR SAFE DRIVING

(71) Applicant: HON HAI PRECISION INDUSTRY CO., LTD., New Taipei (TW)

(72) Inventor: DA-YI PENG, New Taipei (TW)

(21) Appl. No.: 14/684,838

(22) Filed: Apr. 13, 2015

(30) Foreign Application Priority Data
Dec. 11, 2014 (CN) 201410755376.3

(51) Int. Cl. B60W 40/09

(52) U.S. Cl. CPC B60W 40/09; B60W 2040/0818

(57) ABSTRACT

A safe driving system includes an acquisition module, a determination module, a control module, and an alarm module. The acquisition module acquires data indicating a driving state of a vehicle and a physical state of a driver of the vehicle. The determination module compares the data obtained by the acquisition module with a plurality of preset values and a plurality of preset time ranges, and thereby determines that the vehicle is in a dangerous driving state and determine associated with the dangerous driving state, and upon such determination, send a signal to a control module. The control module is configured to activate the alarm module to issue an alarm to prompt the driver to calmly drive the vehicle upon receipt of the signal from the determination module.

### CROSS-REFERENCE TO RELATED APPLICATIONS

This application claims priority to Chinese Patent Application No. 201410755376.3 filed on Dec. 11, 2014, the contents of which are incorporated by reference herein.

### FIELD

The subject matter herein generally relates to safe driving, and particularly to a system, a method, and a vehicle for safe driving.

### BACKGROUND

Nowadays, with the rapid advance and development in technology, a safety factor of a vehicle, such as a truck, a car, a bus, or the like, becomes higher. However, traffic accidents were still happened due to a driver's improper operations, such as driver fatigue, drunk driving, or bad emotions.

### BRIEF DESCRIPTION OF THE DRAWINGS

Implementations of the present technology will now be described, by way of example only, with reference to the attached figures.

FIG. 1 is a block diagram of an embodiment of a safe driving system applied to a vehicle.

FIGS. 2 and 3 illustrate a flowchart of an embodiment of a safe driving method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising” when utilized, means “including, but not necessarily limited to”; it specifically indicates open-ended inclusion or membership in the so-described combination, group, series and the like.

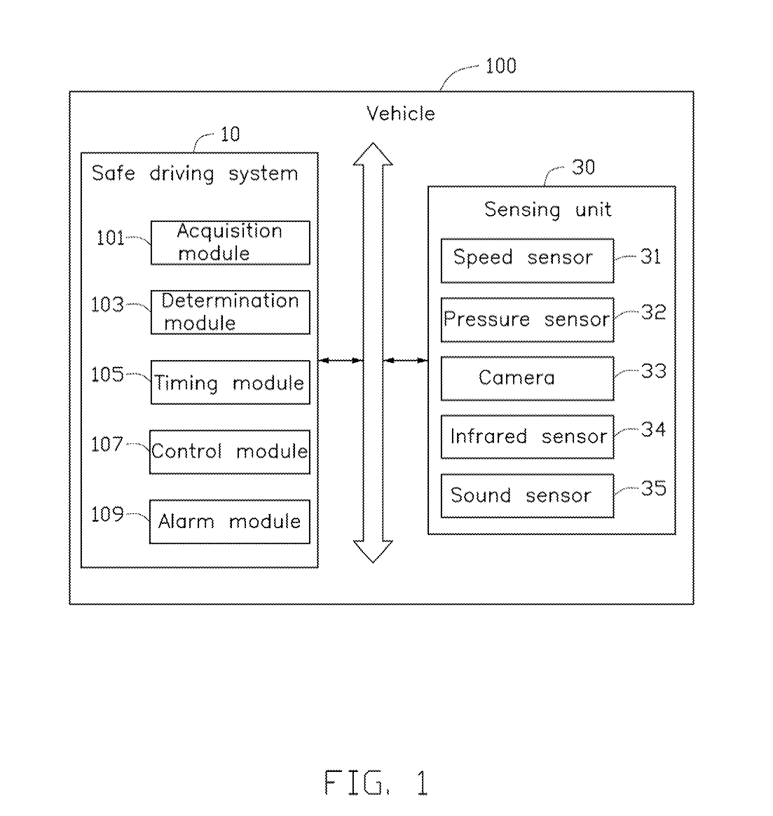

FIG. 1 illustrates a block diagram of an embodiment of a safe driving system 10 applied to a vehicle 100. The vehicle 100 can be a truck, a car, a bus, or the like. The safe driving system 10 is electrically connected to an electronic control unit (ECU) of the vehicle 100. The safe driving system 10 is configured to monitor both a driving state of the vehicle 100 and a physical state of a driver of the vehicle 100 so as to remind the driver to calmly drive the vehicle 100, thereby preventing traffic accidents that can happen due to the driver's improper operations, such as driver fatigue, drunk driving, or unstable emotions and ensuring a safety of the driver.

The vehicle 100 further includes at least one group of sensing unit 30. The at least one group of the sensing unit 30 includes various sensors and camera devices for monitoring both the driving state of the vehicle 100 and the physical state of the driver of the vehicle 100. In this embodiment, the at least one group of sensing unit 30 includes a speed sensor 31, at least one pressure sensor 32, a camera 33, an infrared sensor 34, and a sound sensor 35, which are all electrically connected to the ECU of the vehicle 100.

The speed sensor 31, the at least one pressure sensor 32, and the camera 33 are configured to cooperatively monitor the driving state of the vehicle 100. In detail, the speed sensor 31 is secured on the vehicle 100 and is configured to detect movement information of the vehicle 100, such as a driving speed or an acceleration of the vehicle 100. The at least one pressure sensor 32 can be located on a vehicle heat or a steering wheel of the vehicle 100. The at least one pressure sensor 32 is configured to detect a pressure value of the vehicle heat and the steering wheel. The camera 33 can be mounted on a windshield (not shown) of the vehicle 100 for capturing various images to be analyzed whether the vehicle 100 has any abnormal migrations when turning.

The infrared sensor 34 and the sound sensor 35 are configured to cooperatively monitor the physical state of the driver of the vehicle 100. In detail, the infrared sensor 34 is configured to detect a temperature or/and a heart rate of the driver. The sound sensor 35 is located in an interior of the vehicle 100 and is configured to detect a sound decibel in the vehicle 100.

The safe driving system 10 includes an acquisition module 101, a determination module 103, a timing module 105, a control module 107, and an alarm module 109. The acquisition module 101 is configured to acquire data from the group of sensing unit 30 indicating the driving state of the vehicle 100 and the physical state of the driver of the vehicle 100.

The determination module 103 stores a plurality of preset values and a plurality of preset time ranges. The determination module 103 is configured to compare the data obtained by the acquisition module 101 with the plurality of preset values and the plurality of preset time ranges, thereby determining whether the vehicle 100 is in a dangerous driving state and a danger level. In this embodiment, the plurality of preset values includes a preset pressure value of the vehicle heat or the steering wheel, a preset temperature value of the driver, a preset heart rate range of the driver, a preset migration range when the vehicle 100 turning, a preset sound decibel in an interior of the vehicle 100. When one or more selected from the detected pressure value, the detected temperature value, the detected heart rate value, the detected sound decibel value, and the detected migration value of the vehicle 100 exceed the corresponding preset value, the determination module 103 determines that the vehicle 100 is in the dangerous driving state.

The timing module 105 is configured to be activated to start timing when the determination module 103 determines that the vehicle 100 is in the dangerous driving state.

The determination module 103 further compares the detected time from the timing module 105 with the preset time ranges to determine the danger level of the vehicle 100. In this embodiment, the plurality of preset time ranges includes a preset first time range, a preset second time range, and a preset third time range. Then, when the detected time from the timing module 105 satisfies the preset first time range, such as 3 minutes<a detected time<5 minutes, the determination module 103 determines the danger level of the vehicle 100 as a low danger level. When the detected time from the timing module 105 satisfies the preset second time range, such as 5 minutes<a detected time<8 minutes, the determination module 103 determines the danger level of the vehicle 100 as a medium danger level. When the detected time from the timing module 105 satisfies the preset third time range, such as 8 minutes<a detected time, the determination module 103 determines the danger level of the vehicle 100 as a high danger level.

The control module 107 is electrically connected to the determination module 103 and is configured to activate the alarm module 109 according to the detection of the determination module 103.

The alarm module 109 can issue an alarm for reminding the driver to calmly drive the vehicle 100 by means of sound, light, vibration, or the like. In this embodiment, the alarm module 109 can be selected one or more from a group consisting of lighting system, audio system, calling system, and braking system. In detail, when the determination module 103 determines the vehicle 100 is in the low danger level, the control module 107 controls the lighting system of the alarm module 109 to blink and controls the audio system of the alarm module 109 to remind the drive to pay attention. When the determination module 103 determines the vehicle 100 is in the medium danger level, the control module 107 controls the lighting system of the alarm module 109 to blink, controls the audio system of the alarm module 109 to remind the drive to pay attention, and controls the braking system of the alarm module 109 to decrease a driving speed of the vehicle 100. When the determination module 103 determines the vehicle 100 is in the high danger level, the control module 107 controls the lighting system of the alarm module 109 to blink, controls the audio system of the alarm module 109 to remind the drive to pay attention, controls the braking system of the alarm module 109 to decrease a driving speed of the vehicle 100, and controls the calling system of the alarm module 109 to dial according to a preset telephone number.

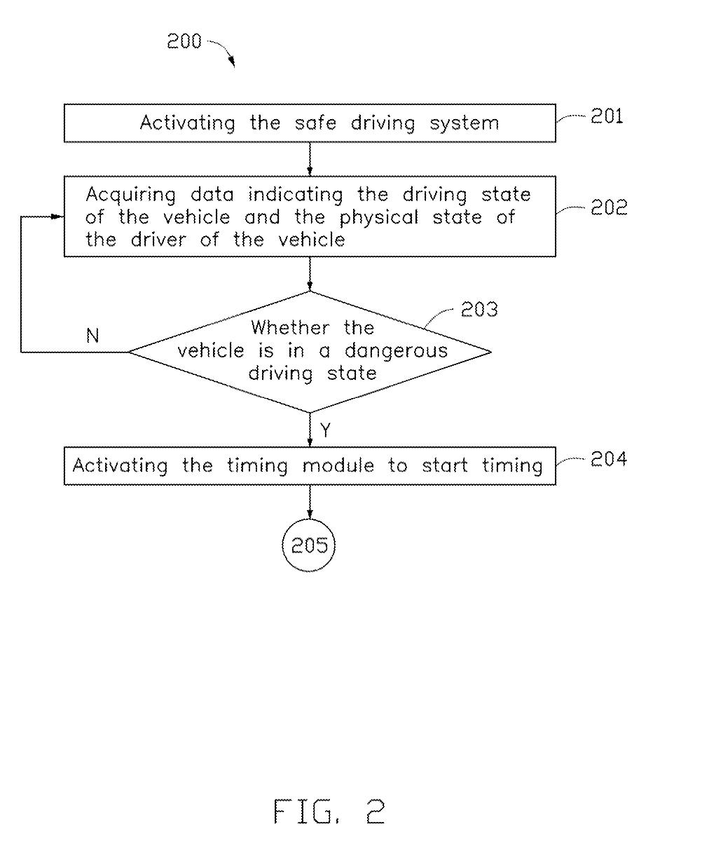

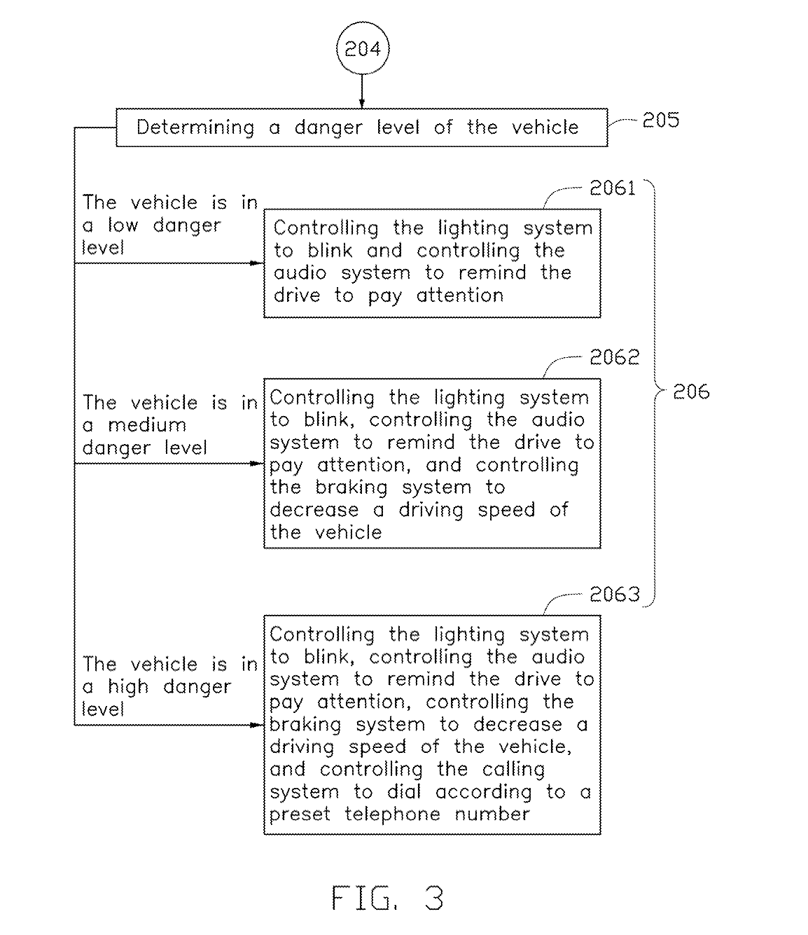

Referring to FIGS. 2 and 3, a flowchart is presented in accordance with an example embodiment which is being thus illustrated. The example method 200 is provided by way of example, as there are a variety of ways to carry out the method. The method 200 described below can be carried out using the configurations illustrated in FIG. 1, for example, and various elements of these figures are referenced in explaining example method 200. Each block shown in FIGS. 2 and 3 represents one or more processes, methods or subroutines, carried out in the exemplary method 200. Furthermore, the illustrated order of blocks is by example only and the order of the blocks can change according to the present disclosure. Additional blocks may be added or fewer blocks may be utilized, without departing from this disclosure. The exemplary method 200 can begin at block 201.

At block 201, the vehicle is actuated to activate the safe driving system.

At block 202, the acquisition module acquires data from the group of sensing unit indicating the driving state of the vehicle and the physical state of the driver of the vehicle, and transmits the data to the determination module.

At block 203, the determination module compares the data obtained by the acquisition module with the plurality of preset values, thereby determining whether the vehicle is in a dangerous driving state.

At block 204, the timing module is activated to start timing when the determination module determines the vehicle is in the dangerous driving state.

At block 205, the determination module compares the detected time from the timing module with the preset time ranges to determine a danger level of the vehicle.

At block 206, the control module activates the alarm module according to the detection of the determination module.

In detail, at block 2061, when the determination module determines the vehicle is in a low danger level, the control module controls the lighting system of the alarm module to blink and controls the audio system of the alarm module to remind the drive to pay attention.

At block 2062, when the determination module determines the vehicle is in a medium danger level, the control module controls the lighting system of the alarm module to blink, controls the audio system of the alarm module to remind the drive to pay attention, and controls the braking system of the alarm module to decrease a driving speed of the vehicle.

At block 2063, When the determination module determines the vehicle is in a high danger level, the control module controls the lighting system of the alarm module to blink, controls the audio system of the alarm module to remind the drive to pay attention, controls the braking system of the alarm module to decrease a driving speed of the vehicle, and controls the calling system of the alarm module to dial according to a preset telephone number.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A safe driving system comprising:
an acquisition module configured to acquire data indicating a driving state of a vehicle and a physical state of a driver of the vehicle;
a determination module configured to compare the data obtained by the acquisition module with a plurality of preset values and a plurality of preset time ranges, and thereby determine that the vehicle is in a dangerous driving state and determine associated with the dangerous driving state, and upon such determination, send a signal to a control module;
an alarm module; and
wherein the control module is configured to activate the alarm module to issue an alarm to prompt the driver to calmly drive the vehicle upon receipt of the signal from the determination module.

2. The safe driving system of claim 1, further comprising a timing module; wherein the timing module is configured to start timing when the determination module determines the vehicle is in the dangerous driving state till the determination module determines the vehicle is out of the dangerous driving state.

3. The safe driving system of claim 2, wherein the determination module compares the detected time from the timing module with the plurality of preset time ranges to determine a danger level of the vehicle.

4. The safe driving system of claim 3, wherein when the detected time from the timing module satisfies a preset first time range, the determination module determines the danger level of the vehicle as a low danger level; when the detected time from the timing module satisfies a preset second time range, the determination module determines the danger level of the vehicle as a medium danger level, and when the detected time from the timing module satisfies a preset third time range, the determination module determines the danger level of the vehicle as a high danger level.

5. The safe driving system of claim 4, wherein when the determination module determines the danger level of the vehicle as the low danger level, the control module controls a lighting system of the alarm module to blink and controls an audio system of the alarm module to remind the driver to pay attention.

6. The safe driving system of claim 4, wherein when the determination module determines the danger level of the vehicle as the medium danger level, the control module controls a lighting system of the alarm module to blink, controls an audio system of the alarm module to remind the drive to pay attention, and controls a braking system of the alarm module to decrease a driving speed of the vehicle.

7. The safe driving system of claim 4, wherein when the determination module determines the danger level of the vehicle as the high danger level, the control module controls a lighting system of the alarm module to blink, controls an audio system of the alarm module to remind the driver to pay attention, controls a braking system of the alarm module to decrease a driving speed of the vehicle, and controls a calling system of the alarm module to dial according to a preset telephone number.

8. A vehicle comprising:
at least one group of sensing unit configured to monitor a driving state of the vehicle and a physical state of a driver of the vehicle; and
a safe driving system comprising:
an acquisition module configured to acquire data from the at least one group of sensing unit;
a determination module configured to compare the data obtained by the acquisition module with a plurality of preset values and a plurality of preset time ranges, and thereby determine that the vehicle is in a dangerous driving state and determine associated with the dangerous driving state, and upon such determination, send a signal to a control module;
an alarm module; and
wherein the control module is configured to activate the alarm module to issue an alarm to prompt the driver to calmly drive the vehicle upon receipt of the signal from the determination module.

9. The vehicle of claim 8, wherein the safe driving system further comprises a timing module, the timing module is configured to start timing when the determination module determines the vehicle is in the dangerous driving state.

10. The vehicle of claim 9, wherein the determination module compares the detected time from the timing module with the plurality of preset time ranges to determine a danger level of the vehicle.

11. The vehicle of claim 10, wherein when the detected time from the timing module satisfies a preset first time range, the determination module determines the danger level of the vehicle as a low danger level; when the detected time from the timing module satisfies a preset second time range, the determination module determines the danger level of the vehicle as a medium danger level, and when the detected time from the timing module satisfies a preset third time range, the determination module determines the danger level of the vehicle as a high danger level.

12. The vehicle of claim 11, wherein when the determination module determines the danger level of the vehicle as the low danger level, the control module controls a lighting system of the alarm module to blink and controls an audio system of the alarm module to remind the drive to pay attention.

13. The vehicle of claim 11, wherein when the determination module determines the danger level of the vehicle as the medium danger level, the control module controls a lighting system of the alarm module to blink, controls an audio system of the alarm module to remind the drive to pay attention, and controls a braking system of the alarm module to decrease a driving speed of the vehicle.

14. The vehicle of claim 11, wherein when the determination module determines the danger level of the vehicle as the high danger level, the control module controls a lighting system of the alarm module to blink, controls an audio system of the alarm module to remind the drive to pay attention, controls a braking system of the alarm module to decrease a driving speed of the vehicle, and controls a calling system of the alarm module to dial according to a preset telephone number.

15. A safe driving method comprising:
acquiring data indicating a driving state of a vehicle and a physical state of a driver of the vehicle;
determining whether the vehicle is in a dangerous driving state;
timing when the determination module determines the vehicle is in the dangerous driving state;
comparing the detected time with a plurality of preset time ranges to determine a danger level of the vehicle; and
activating the alarm module according to the detection of the determination module.

16. The method of claim 15, wherein when the vehicle is determined in a low danger level, the step of activating the alarm module comprising:
controlling a lighting system to blink; and
controlling an audio system to remind the drive to pay attention.

17. The method of claim 15, wherein when the vehicle is determined in a medium danger level, the step of activating the alarm module comprising:
controlling a lighting system to blink;
controlling an audio system to remind the drive to pay attention; and
controlling a braking system to decrease a driving speed of the vehicle.

18. The method of claim 15, wherein when the vehicle is determined in a high danger level, the step of activating the alarm module comprising:
controlling a lighting system to blink;
controlling an audio system to remind the drive to pay attention;
controlling a braking system to decrease a driving speed of the vehicle; and
controlling a calling system to dial according to a preset telephone number.
